(19) United States
(12) Patent Application Publication
(10) Pub. No.: US 2018/0027103 A1
(43) Pub. Date: Jan. 25, 2018

(54) Wearable computing communication device with display screens and methods.

(71) Applicant: Alexander Gonzales Chacon, Reno, NV (US)

(72) Inventor: Alexander Gonzales Chacon, Reno, NV (US)

(21) Appl. No.: 15/217,291

(22) Filed: Jul. 22, 2016

(51) Int. Cl. H04M 1/725

(52) U.S. Cl. CPC H04M 1/7253; H04B 1/385

(57) ABSTRACT

A wearable computing device (WCD) which provides for new and alternative methods of communication and social interaction. The WCD is mobile and allows the wearer to show, share, play and or generally broadcast various forms of multimedia content on one or more display screens. One or more display screens face outward, away from the WCD wearer, so that others may see, hear, receive and generally experience the content and information projected from the outward facing display screen(s). The WCD presents information on one or more display screens for the wearer to see, hear, receive and generally experience the content and information projected from the display screen(s). The WCD receives or retrieves various forms of multimedia content and electronic information from various external electronic sources and devices such as mobile phones, tablets, laptop computers, desktop computers, smartwatches, smart devices, IoT connected devices, game consoles, computing devices, computer systems, PDAs, sensors, beacons, detectors, image displays, audio processors, electronic information transmitters and other electronic computing devices or systems.

### BACKGROUND

A wearable computing device (WCD) which provides for new and alternate methods of communication and social interaction in various social settings. The WCD assists with communication where surrounding social, environmental, industrial, corporate, medical, circumstantial or work related settings make it inappropriate, impossible, undesirable, difficult or dangerous to rely solely on audio forms of communication or solely on visual forms of communication.

The WCD creates opportunities for new and useful forms of communication which help overcome barriers that prevent, block, inhibit or hinder conversation, communication, knowledge transfer, learning or understanding among or between individuals in various social, environmental, industrial, corporate, medical, circumstantial or work related settings.

### SUMMARY

The wearable computing device (WCD) provides for alternate forms of communication using one or more display screens, speakers plus other device hardware and software. The WCD enables the wearer to broadcast multimedia content, and communicate with others by projecting multimedia content from one or more outward facing display screens, display screens which face away from the wearer, so that others may hear, view and generally receive or experience the communication. The multimedia content projected from the outward facing display screen(s) may be generated, sourced, streamed or shared from external electronic devices or sources. The other party or parties receiving the communication may communicatively respond by voice, gesture or other natural method, smart device or computing device, or by also wearing a like kind of WCD.

### BRIEF DESCRIPTION OF THE DRAWINGS

FIG. 1

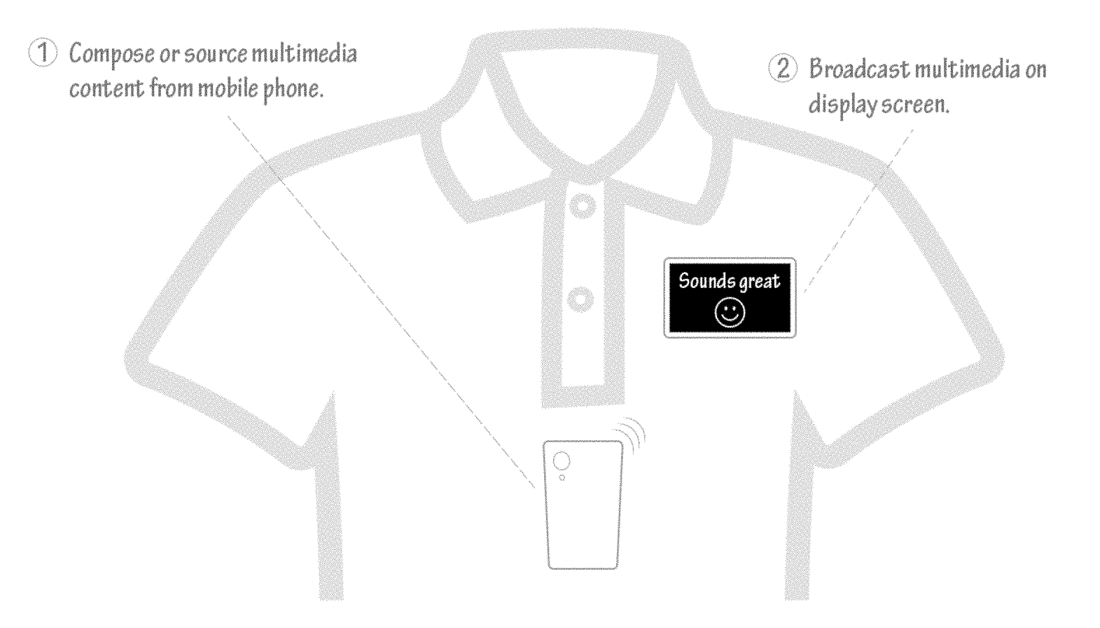

Illustrates a short process whereby an individual using the wearable computing device (WCD) composes or sources multimedia content from a mobile phone and then transmits the multimedia content to the WCD for projection or broadcast on an outward facing display screen so that others may hear, view and generally receive or experience the multimedia content.

### DETAILED DESCRIPTION

### 1. Overview

The wearable computing device (WCD) is capable of displaying and broadcasting various forms of multimedia content and electronic information including but not limited to text, images, photos, icons, emoticons, stickers, various electronic artworks, audio, music, video, social content, ASCII files, binary files, and other multimedia in various file formats or electronic transfer which is sourced, shared and or streamed from external electronic computing devices and sources.

The WCD is worn by an individual and includes one or more display screens. One or more display screens face outward, away from the device wearer, so that multimedia content and information displayed on screen may be viewed, heard, received and generally experienced by others. The WCD is controlled and operated by software which is proprietary, open source, original and modified. The WCD and system software may be updated on an ongoing basis at various times. Hardware components of the WCD may also be updated at various times.

The WCD is capable of receiving or retrieving various forms of multimedia content and electronic information from various external electronic devices including but not limited to mobile phones, tablets, laptop computers, desktop computers, smartwatches, smart devices, IoT connected devices, game consoles, computing devices, computer systems, PDAs, sensors, detectors, electric transmitters and sources, other electronic computing devices.

The WCD is capable of receiving or retrieving various forms of multimedia content and electronic information from various external software including but not limited to mobile applications, web applications, the internet, the world wide web, publicly available information feeds, and from generally compatible information producing software and systems.

The WCD is capable of receiving or retrieving various forms of multimedia content and electronic information via various information transfer and delivery technologies such as but not limited to bluetooth, Wi-Fi, WiMAX, NFC, USB, wireless USB, ZigBee, micro-USB, mobile networks, cellular networks such as CDMA, EVDO, GSM, GPRS, EDGE, 2G, 3G, 4G, 5G, LTE, XLTE, VoLTE, EV-DO, W-CDMA, HSPA, UMTS, VoIP, wired connections, wireless technologies, cables, LAN, WAN, PAN, WLAN, IR, RF, RFID, QR, UHF, ISM, wireless sensor Networks (WSN/WSAN) network connections, dongles, the internet, the world wide web, satellite, radio waves, servers, databases, closed networks, and generally any compatible method of information delivery.

WCD display screens may vary where screen types may include technologies which include but are not limited to LCD, LED, OLED, TFT, plasma, CFL, amoled, super amoled, ITS, HD, quad HD, super HD, CRT, ELD, PDP, HPA, SED, FED, IMOD, DMS, laser or crystal displays.

The WCD is available in various models, in varying sizes, with varying options and with differing hardware and software configurations.

The WCD is capable of running publicly available software such as but not limited to mobile applications, web applications, open source software, software available via the internet or the world wide web and other generally compatible software. The WCD is capable of running proprietary software applications. Mobile applications run natively on the WCD.

The WCD may also include features including but not limited to touch sensitive display screen(s), camera, camera flash, video recorder, GPS, Wi-Fi, wireless mobile communication radios, wireless connections, SSD, speakers, microphone, memory, expandable memory, storage, expandable storage, bluetooth, NFC, power supply, battery recharging, various physical ports and connections in support of information transfer, haptic feedback & functions, location awareness and response, the ability to run mobile and web applications and operating systems of various kinds.

### 2. Process

Multimedia Content

Multimedia content or electronic information is composed on, streamed, shared or sourced from but not limited to electronic computing devices or other electronic sources which are external to the wearable computing device (WCD). Multimedia content is also sourced from the WCD itself.

Information Transfer

The multimedia content or electronic information is then subsequently shared, streamed or otherwise electronically transmitted to the WCD for processing, storage and or computing.

Broadcast

Multimedia content or electronic information which has been received or retrieved, and which has completed any necessary processing or computing is then projected on one or more outward facing display screens, so that others may see, hear, receive and generally experience the multimedia content and information emanating from the outward facing display screen(s). The WCD may also consume or generally experience multimedia content.

Media Types

Multimedia content or electronic information may include but is not limited to, text, images, photos, icons, emoticons, stickers, various electronic artworks, audio, video, music, social media, messaging, signals, sensory information or generally any ASCII or binary based files, or other various forms of electronic data and information.

### 3. Example Use

The wearable computing device (WCD) assists with communication where individuals are temporarily or permanently unable to speak normally or audibly using their natural voice as a result of illness, injury, medical disorder, speech impairment or impediment, disability or debilitating circumstances of various kinds.

The WCD provides for alternate methods of communication where individuals are not able to, or choose not to use their natural voice for wellness purposes such as voice rest, elective silence, medical recommendation or remedy, or preventative care of various kinds.

The WCD assists with communication where surrounding social, environmental, industrial, corporate, medical, circumstantial or work related settings make it inappropriate, undesirable, difficult or dangerous to rely solely on audio forms of communication or solely on visual forms of communication.

The WCD is assistive in translating text and content rich multimedia communications from one language to another.

The WCD provides new ways for individuals to be social without necessarily being vocal.

The WCD may display static or real time multimedia content which may or may not be pinned by the wearer.

The WCD is location aware and presents the wearer with options based on geographic location.

WCD sensors may read surrounding environments and optionally change modes and prevent the wearer with various options.

The WCD may track vital medical information of the individual wearer and display medical information on screen or execute various actions or functions in emergency situations.

Using artificial intelligence the WCD may learn the wearer's natural voice and artificially speak on behalf of the wearer in various social settings or as needed for medical circumstances, wellness purposes or general use applications.

The WCD is WCD aware and may interact or communicate automatically with devices of like kind.

The WCD is capable of displaying manual or automatic idle time information on one or more display screens.

The WCD is capable of reading, recording, sensing, collecting and transmitting or transferring information to other electronic and computing devices.

### 4. Practical Application

Use case examples for the wearable computing device (WCD).

An individual who is unable to speak may compose a multimedia message on their mobile phone, using a mobile application, and then transmit the message to the WCD display screen(s) so that others may view and or hear what is being communicated by the device wearer.

An individual may select content on their mobile phone such as an image, photo, photo gallery, icon, emoticon, sticker, various electronic artwork or other image file, using a mobile application, and then share the selected content to the WCD display screen(s) so that others may view the content being shared by the device wearer.

An individual may share or stream music, audio, video or social content from their mobile phone, using a mobile application, and then transmit the video or social content to the WCD display screen(s) so that others may view and or hear what is being communicated by the device wearer.

An individual traveling overseas may ask for directions to the airport by composing a multimedia message on their mobile phone in their native language, and then project a translated multimedia message from the WCD display screen(s) so that others may view, read, and or hear the translated message in their own native language or a language which they understand.

An individual works in an industrial setting where the risk of physical injury or danger is elevated. Heavy equipment, engines, tools and or machinery makes audible communication difficult, impractical or impossible. The WCD shows communication, messaging and or signals on a display screen to assist with communication.

An individual arrives at home and a display screen automatically shows a message of “Home sweet home.”

An individual arrives in proximity to a dear family member and the WCD uses facial recognition to project a customized greeting to the family member.

Where two individuals are each independently wearing a WCD, have a relationship or friendship, and come in close proximity the WCD's may react with an affectionate response such as projecting a multimedia message which reads “Hi honey.” and may also include haptic feedback, functions or response the wearer can actually feel.

The WCD can be set to a listening translation mode where the WCD hears a language foreign to the wearer and then translates audio, text or multimedia to the wearer's native or primary language.

An individual may optionally set the WCD to project idle time multimedia. Multimedia content such as but not limited to local time and or weather, sporting or event information, name or other personal information, a photo or photos, social media content or imagery, or generally any content pinned by the wearer.

An individual may select to pin an image, quote or multimedia content to a display screen to show support or solidarity for a cause.

The WCD may optionally monitor medical vital signs of the wearer and display emergency info on screen in the event of a medical emergency. In these situations the WCD may optionally also alert important contacts such as family members.

### 5. Wearing the Wearable Computing Device

The wearable computing device (WCD) may be affixed, fastened, attached or strapped to various parts of the body including the torso, chest, arm, shoulder, waist area, back, hip or virtually any area deemed suitable by the user depending on the situation, surroundings, or settings. The WCD may be suspended from the neck area such as with a harness, lanyard or other accessory, or held to the body using straps, velcro, other accessories or various magnetized accessories. The WCD may also be affixed, fastened, attached or strapped to a hat, cap, helmet, shirt, pants, shorts, dress, jacket, sweater, suit, skirt, belt and other various articles of clothing, purses, bags or other accessories.

What is claimed:

1-14. (canceled)

15. A Wearable Computing Communication Device (WCCD), comprising mobile device technology, which provides for an individual wearing the WCCD to effectively communicate and engage in dynamic two-way conversation(s), with one or more individuals, without using their natural audible voice.

16. The WCCD of claim 15, employing artificial intelligence (AI), where the WCCD may learn the natural audible voice of an individual wearing the WCCD, and thereafter where the WCCD may audibly speak on behalf of the individual wearing the WCCD, when or where the individual cannot speak naturally with his or her own voice, or where the individual elects not to speak for a given time, or under certain circumstances, or during certain social settings, or when the individual wishes to use the WCCD for reasons such as entertainment, fun, or leisure.

17. The WCCD of claim 15, comprising internal software and code, self-generates multimedia messaging and electronic content such as audio, video, pictures, music, graphics, icons, emoji, text and or other light signals, which is subsequently broadcasted by the WCCD using one or more speakers and one or more outward facing display screens which face away from the individual wearing the WCCD, so that the multimedia and or messaging may be seen and or heard by one or more other individuals engaging in dynamic two-way conversation with the individual wearing the WCCD.

18. The WCCD of claim 15, comprising software and code which is external to the WCCD such as a mobile application, which is installed on a compatible mobile phone and or other compatible device, where electronic content, data, and multimedia messaging is authored on or sourced from the mobile phone, and where the external content such as audio, video, pictures, music, graphics, icons, emoji, text and or other light signals, is electronically and or wirelessly transferred to the WCCD for processing and then broadcasting to one or more other individuals engaging in dynamic two-way conversation with the individual wearing the WCCD.

19. The WCCD of claim 15, comprising hardware components, including one or more outward facing display screens which face away from the individual wearing the WCCD, including a rigid casing such as is common with current day mobile phones, including one or more speakers, including a microphone, including battery power, including memory and processors, including physical buttons and or switches, including data and or power ports and or connectors, including wireless components which send and receive wireless data, and or including touch sensitive display screen(s), including storage or expandable storage, including bluetooth and NFC, and or including a camera, and or including GPS (Global Positioning System), and or including haptic feedback functionality, and or including location awareness and response, and or including other mobile technology components, all of which allow the individual wearing the WCCD to author, receive and broadcast electronic content, data, multimedia messaging and or light messaging to one or more other individuals.

20. The WCCD of claim 15, comprising device accessories, which are used to affix the device to the body, where the positioning of the device on the body is (commonly though not exclusively) near the upper torso of an individual, where the device positioning is achieved by using an accessory similar to a lanyard or other compatible accessory.

21. The WCCD of claim 15, comprising mobile technology, presents the user with location based data, menu options and or smart clipboards with quick access to useful content.

22. The WCCD of claim 15, comprising mobile technology, where the individual may compose a message in their native language such as English, and where thereafter the WCCD will broadcast the translated message in another language such as Spanish.

23. The WCCD of claim 15, comprising mobile technology, where the device may be placed in a listening mode, where the user's native language is English, and where the device may comprehend a language foreign to the individual wearing the WCCD, and where the device will print the communication in English onto one of its display screens.

24. The WCCD of claim 15, comprising mobile technology, where the individual may elect to virtually “pin” selected multimedia content or messaging such as a picture or text, for a period of time, onto one of the display screens.

25. The WCCD of claim 15, comprising mobile technology, where the WCCD recognizes when other WCCD's are within proximity, where the WCCD's may automatically react to each other based on proximity, such as by displaying a greeting or such as by displaying an affectionate message and or including haptic feedback.

26. The WCCD of claim 15, comprising mobile technology, where the WCCD employs facial recognition, where the WCCD identifies another individual such as a friend or family member, where the WCCD may automatically display a greeting or an affectionate message and or including haptic feedback.

27. The WCCD of claim 15, comprising mobile technology, where the device displays multimedia while idle or not in active use by the wearer, where idle time multimedia is such as time, weather or sporting information or other multimedia as determined by the user.

28. The WCCD of claim 15, comprising mobile technology, where the device sensors or cameras may actively evaluate surrounding environments, optionally change device/software modes and present the wearer with various information or beneficial features and options.

29. The WCCD of claim 15, comprising mobile technology, where when used in conjunction with compatible anatomical sensors, the device may track vital medical information of the individual and display medical information on screen or execute various actions or functions in emergency situations.

30. The WCCD of claim 15, comprising mobile technology, where the WCCD projects light messaging or light signals that can be viewed by others from a distance, in settings where audible communication is difficult, impractical or impossible, where from a distance text and image details are not discernible but light based signals or messaging are comprehensible.
